(19) United States
(12) Patent Application Publication
(10) Pub. No.: US 2023/0098441 A1
(43) Pub. Date: Mar. 30, 2023

(54) BILL AGGREGATION WITH PRE-PAYMENT OUTLIER ALERTS

(71) Applicant: Austin Pritchett, Highland, UT (US)

(72) Inventor: Austin Pritchett, Highland, UT (US)

(21) Appl. No.: 17/487,579

(22) Filed: Sep. 28, 2021

(51) Int. Cl. G06Q 20/10; G06Q 20/14

(52) U.S. Cl. CPC G06Q 20/102; G06Q 20/14

(57) ABSTRACT

A method for aggregating and paying bills is disclosed. In one embodiment, such a method aggregates bills for goods or services rendered. The method parses the bills to determine amounts owed for the goods or services. The method determines whether any of the amounts fall outside of acceptable ranges and generates an alert in the event any of the amounts fall outside of the acceptable ranges. In certain embodiments, the method uses machine learning and/or artificial intelligence to assist in determining the acceptable ranges and whether an amount associated with a particular bill is an outlier. In certain embodiments, when an amount falls outside of an acceptable range, the method links a user to the bill that gave rise to the alert so that the bill can be reviewed and scrutinized prior to being paid. A corresponding system and computer program product are also disclosed and claimed herein.

### BACKGROUND

### Field of the Invention

This invention relates to systems and methods for automating the aggregation and paying of bills.

### Background of the Invention

Most individuals and businesses have myriad bills to deal with each month, and possibly on a more or less frequent basis. These bills may require payments for various goods and services, such as utilities, insurance, rents, mortgages, subscriptions, vehicles, education, memberships, loans, and the like. As an individual's life grows more complex, the number of bills that he or she may have to review and pay may likewise increase. Similarly, as a business grows, the number of bills that the business must keep track of and pay may increase accordingly. This may place additional demands on the individual or a business owner's time in order to keep track and pay the bills in the correct amounts and on time.

In the case of a business, because a business owner or his or her employees may oftentimes wear many hats, they may easily become overwhelmed by the sheer number of bills and may not have enough time or resources to adequately review the bills prior to paying. In such cases, the bills may simply be paid without further review or scrutiny. If mistakes are made, such as overpayments or paying at the wrong time, a significant amount of time and effort may be required to correct such mistakes, if the mistakes are even caught or corrected at all. This can incur significant expense, sometimes unnecessarily, for an individual or business.

### SUMMARY

The invention has been developed in response to the present state of the art and, in particular, in response to the problems and needs in the art that have not yet been fully solved by currently available systems and methods. Accordingly, systems and methods have been developed for automating the aggregation and paying of bills. The features and advantages of the invention will become more fully apparent from the following description and appended claims, or may be learned by practice of the invention as set forth hereinafter.

Consistent with the foregoing, a method for aggregating and paying bills is disclosed. In one embodiment, such a method aggregates bills for goods or services rendered. The method parses the bills to determine amounts owed for the goods or services. The method determines whether any of the amounts fall outside of acceptable ranges and generates an alert in the event any of the amounts fall outside of the acceptable ranges. In certain embodiments, the method uses machine learning and/or artificial intelligence to assist in determining the acceptable ranges and whether an amount associated with a particular bill is an outlier. In certain embodiments, when an amount falls outside of an acceptable range, the method links a user to the bill that gave rise to the alert so that the bill can be reviewed and scrutinized prior to being paid.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing a billing module and various sub-modules in accordance with the invention;

FIG. 3 is a high-level block diagram showing a first example of a user interface that may be used to implement a billing module in accordance with the invention;

FIG. 4 is a high-level block diagram showing a second example of a user interface that may be used to implement a billing module in accordance with the invention;

FIG. 5 is a high-level block diagram showing a third example of a user interface that may be used to implement a billing module in accordance with the invention;

FIG. 6 is a high-level block diagram showing a fourth example of a user interface that may be used to implement a billing module in accordance with the invention;

FIG. 7 is a high-level block diagram showing a fifth example of a user interface that may be used to implement a billing module in accordance with the invention;

FIG. 8 is a high-level block diagram showing a sixth example of a user interface that may be used to implement a billing module in accordance with the invention;

FIG. 9 is a high-level block diagram showing a seventh example of a user interface that may be used to implement a billing module in accordance with the invention;

FIG. 10 is a high-level block diagram showing an eighth example of a user interface that may be used to implement a billing module in accordance with the invention;

FIG. 11 is a high-level block diagram showing a ninth example of a user interface that may be used to implement a billing module in accordance with the invention; and

FIG. 12 is a high-level block diagram showing a tenth example of a user interface that may be used to implement a billing module in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

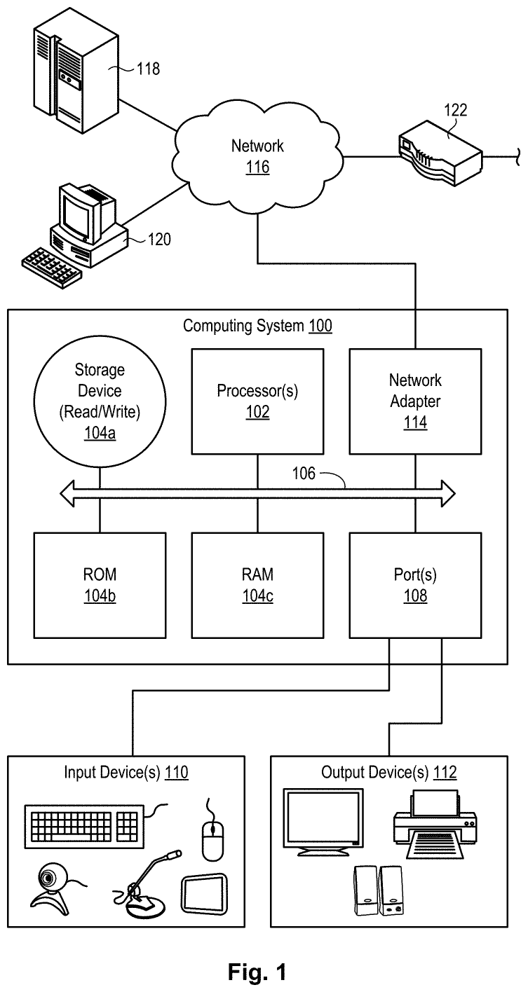

Referring to FIG. 1, one example of a computing system 100 is illustrated. The computing system 100 is presented to show one example of an environment where systems and methods in accordance with the invention may be implemented. The computing system 100 may be embodied as a desktop computer, a workstation, a laptop computer, a server, a storage controller, a mobile device such as a smart phone or tablet, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a local area network (LAN), wide area network (WAN), storage area network (SAN), or the Internet. Such a network 116 may enable the computing system 100 to connect to or communicate with one or more servers 118, workstations 120, personal computers 120, mobile computing devices, or other devices. The network 116 may also enable the computing system 100 to connect to or communicate with another network by way of a router 122 or other device 122. Such a router 122 may allow the computing system 100 to communicate with servers, workstations, personal computers, or other devices located on different networks.

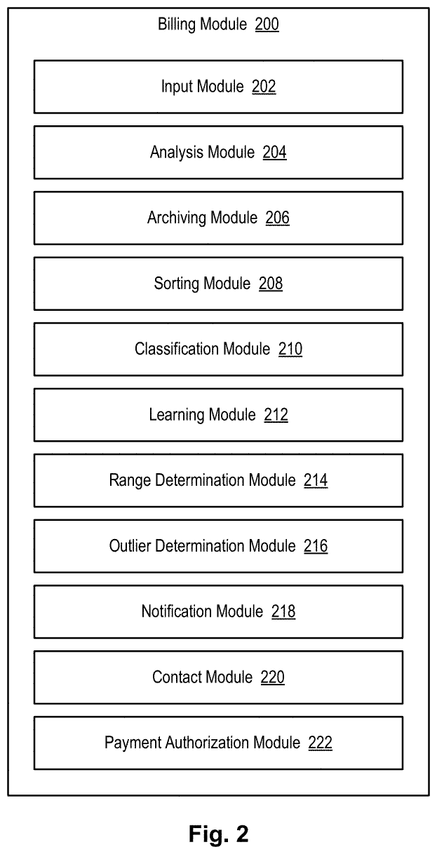

Referring to FIG. 2, as previously mentioned, most individuals and businesses have myriad bills to deal with each month, and possibly on a more or less frequent basis. These bills may require payments for various goods and services, such as utilities, insurance, rents, mortgages, subscriptions, vehicles, education, memberships, loans, and the like. As an individual's life grows more complex, the number of bills that he or she may have to review and pay may likewise increase. Similarly, as a business grows, the number of bills that the business must keep track of and pay may increase accordingly. This may place additional demands on the individual or a business owner's time in order to keep track and pay the bills in the correct amounts and on time.

In the case of a business, because a business owner or his or her employees may oftentimes wear many hats, they may easily become overwhelmed by the sheer number of bills and may not have enough time or resources to review the bills prior to paying. In such cases, the bills may simply be paid without any further review or scrutiny. If mistakes are made, such as overpayments or paying at the wrong time, a significant amount of time and effort may be required to correct such mistakes, if the mistakes are even caught and addressed at all. This can incur significant expense, sometimes unnecessarily, for an individual or business.

In order to address the issues identified above, a billing module 200 may be provided to automate the aggregating and paying of bills. The billing module 200 may include various sub-modules 202-222 that provide various features and functions. The billing module 200 and associated sub-modules 202-222 may be implemented in hardware, software, firmware, or combinations thereof. The billing module 200 and associated sub-modules 202-222 are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, the billing module 200 may include one or more of an input module 202, analysis module 204, archiving module 206, sorting module 208, classification module 210, learning module 212, range determination module 214, outlier determination module 216, notification module 218, contact module 220, and payment authorization module 222.

The input module 202 may be configured import bills into the billing module 200. As previously mentioned, businesses or individuals may receive bills at different intervals, such as every month. These bills may be input into the billing module 200 by various different means. In certain embodiments, the input module 202 may contain scanning functionality to scan a bill into the billing module 200 or take a picture of a bill so that it can be input into the billing module 200. In other embodiments, the input module 202 may scan texts or emails of a business or individual (from a known email address or phone number, for example) to import bills into the billing module 200. In certain embodiments, the input module 202 may be configured to recognize bills arriving in the form of text, email, PDF or word processing documents, or the like, for import into the billing module 200. In yet other embodiments, the billing module 200 may be configured to interface directly to providers of goods and service over the Internet or other networks to import bills into the billing module 200. In such cases, the input module 202 may use login information (provided by an individual or business) for each bill provider to retrieve billing information therefrom. These represent just a few techniques for importing bills into the billing module 200 and are not intended to be limiting. As can be appreciated, since bills are typically generated periodically (e.g., every month), the input module 202 may periodically import bills into the billing module 200 for each provider of goods and/or services.

Once bills are imported into the billing module 200, the analysis module 204 may analyze the bills to extract needed information. For example, the analysis module 204 may extract the amounts of payments that are due, the goods or services and associated amounts that were provided, the names of the providers, due dates, contact information, and the like, from the bills that are imported into the billing module 200. In certain embodiments, the analysis module 204 may parse the text of bills to extract this needed information. In some cases, optical character recognition technology may be used to recognize text in the bills so that this information may be extracted. In other cases, the bills may already arrive in a readable format that the analysis module 204 may then parse and analyze.

The archiving module 206 may archive bills that are received by the billing module 200. As bills come in on a monthly (or other) basis, the archiving module 206 may store the bills in a repository. Over time, this may create a history of bills from various sources. In certain embodiments, the bills may be stored within the billing module 200, locally but outside the billing module 200, in an external location such as in the cloud, or using a combination of these techniques to provide redundancy. In certain embodiments, retention policies may be established for archived bills. For example, bills may be retained for a default or user-selected number of years before they are automatically deleted to clear space in storage.

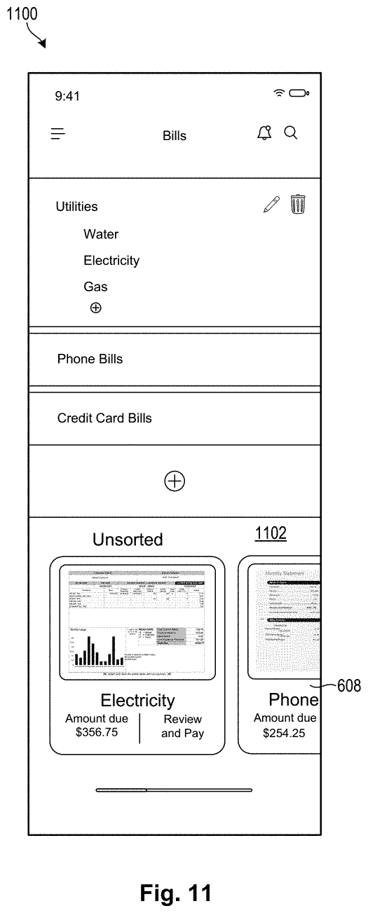

The sorting module 208 may sort bills that are imported into the billing module 200. For example, electric bills may be grouped with other previously received electric bills, insurance bills may be grouped with other previously received insurance bills, and the like. In other cases, sorting may be performed more broadly such as “utility bills” that may encompass multiple different types of bills. In such cases all utility bills (e.g., electric bills, water bills, gas bills, etc.) may be sorted under the same category. In certain embodiments, the classification module 210 may enable a user to generate or edit various categories that the bills may be sorted under. Such a concept will be discussed in more detail in association with FIG. 11.

As bills are received and archived in the billing module 200, the learning module 212 may use technologies such as artificial intelligence and machine learning to learn about the bills. For example, the learning module 212 may, by analyzing text in the bills, obverse the amounts of the bills, goods and services that are being provided, dates that goods and services were provided, due dates, and the like. Using this information, the learning module 212 may learn the approximate amounts of the bills during different times or seasons of the year, as well in which way the amounts are trending or have changed over time.

Using the information learned by the learning module 212, the range determination module 214 may determine normal or customary ranges associated with the amounts. These ranges may indicate what is expected for the amounts in the future, or ranges for the amounts that would be considered normal or expected. In certain embodiments, these normal or customary ranges may differ for different times or seasons of the year. For example, the normal range for an electric bill in the summer may be different than the normal range for an electric bill in the winter. Similarly, the normal range for a gas bill in the summer may be different than the normal range for a gas bill in the winter. The normal or customary range for a specific type of bill may be used by the range determination module 214 to determine an acceptable range for the specific type of bill. For example, the acceptable range may be the normal or customary range plus or minus some selected percentage, such as twenty percent. Any amounts that fall outside this acceptable range may be considered an outlier and thus cause for concern or additional scrutiny. If a bill is received that falls outside this acceptable range, an individual or business may wish to scrutinize the bill further before paying the bill to determine if there was a mistake or if something is causing elevated usage of the good or service that is associated with the bill.

To determine if an amount associated with a bill is an outlier, the outlier determination module 216 may compare the amount associated with a bill to an acceptable range associated with the bill. If the amount falls outside the acceptable range, the outlier determination module 216 may designate the amount as an outlier. In such cases, the notification module 218 may alert a user so that he or she may scrutinize the bill prior to paying. In certain embodiments, when an alert is generated, the notification module 218 may also provide information with the alert such as the extent by which the bill amount exceeded what was expected or how much it exceeded a prior amount paid (e.g., the amount paid the previous month). Other information, such as the amount of the bill, the goods or services associated with the bill, the due date of the bill, the source of the bill, and the like may be provided to the user by the notification module 218.

If a user desires to scrutinize a bill prior to paying, the contact module 220 may provide contact information associated with the bill (i.e., the contact information of the bill provider). This may allow the user to contact the bill provider to dispute the bill and/or find out more information about the bill prior to paying. If the user is satisfied with the bill amount, the payment authorization module 222 may enable the user to pay the bill. For example, the user may click a button or otherwise make a selection to pay the bill. The billing module 200 may then automatically make the payment to the bill provider. In certain embodiments, the payment authorization module 222 may include a database of payment methods as well as contact information for the bill providers. In certain embodiments, the contact information is automatically extracted from the bills and stored in the database by the analysis module 204.

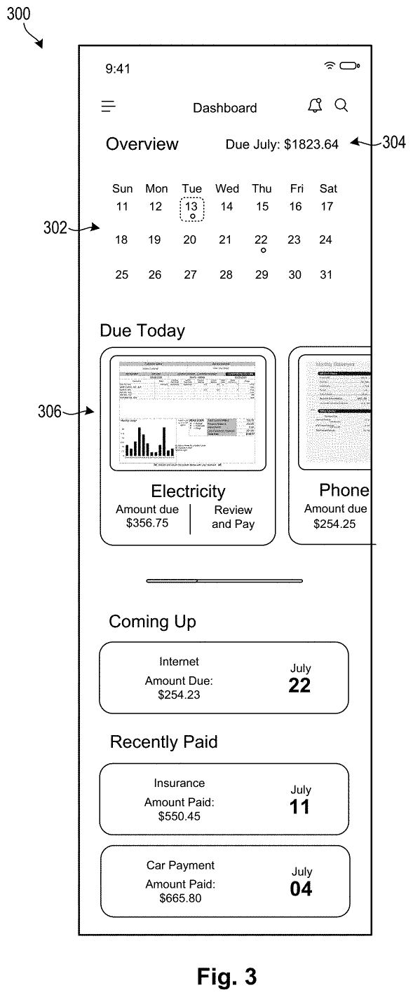

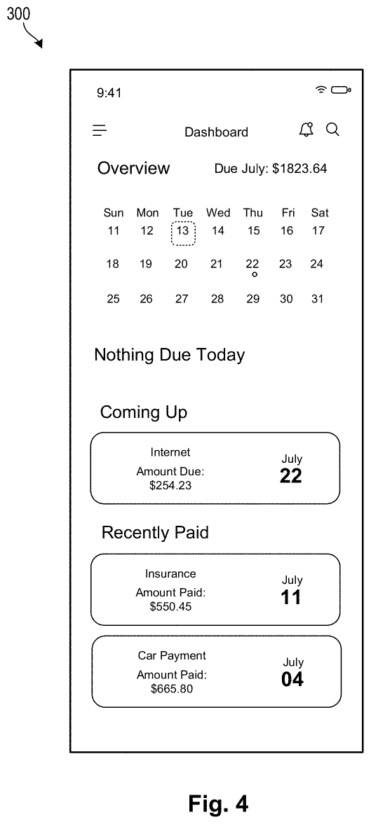

FIG. 3 is a high-level block diagram showing one example of a user interface 300 that may be used to implement a billing module 200 in accordance with the invention. As shown, the user interface 300 (in the example a “dashboard”) provides a calendar 302 that can be used to see past, current, and upcoming bills. A dotted line may indicate the current day on the calendar 302 and an amount 304 may indicate a total amount for bills that are due during the calendar month. In certain embodiments, a dot may indicate on which days of the calendar 302 a bill is due. In the illustrated embodiment, below the calendar 302, the user interface 300 may show a list (in this example a scrollable list) of bills that are due for the current day, as well as bills that are coming up and bills that have been recently paid. In certain embodiments, small snapshots 306 of the bills are provided, which may link to actual digital copies of the bill for review by a user. If the bills are sorted, the user interface 300 may display a category (e.g., “utilities”) for the bills or just a name of the bill provider (e.g., vendor) if the bills are unsorted. FIG. 4 shows a similar user interface 300 as FIG. 3 except without any bills due on the current day.

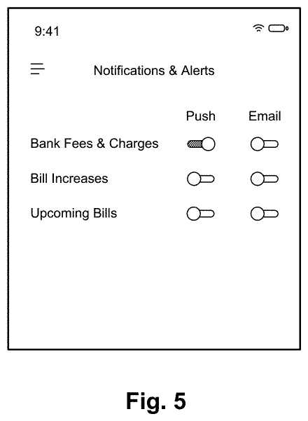

Referring to FIG. 5, in certain embodiments another user interface 500 associated with the billing module 200 may display notification and alert options for the billing module 200. In this example, the user interface 500 provides options for receiving push and email notifications for “bank fees & charges,” “bill increases,” and “upcoming bills.” Some notifications may notify a user immediately when changes are detected and other notifications may notify a user some amount of time before an upcoming event (e.g., a bill needing to be paid). Other types of alerts and notifications, as well as ways of notifying a user (e.g., text messages, etc.), may also be used.

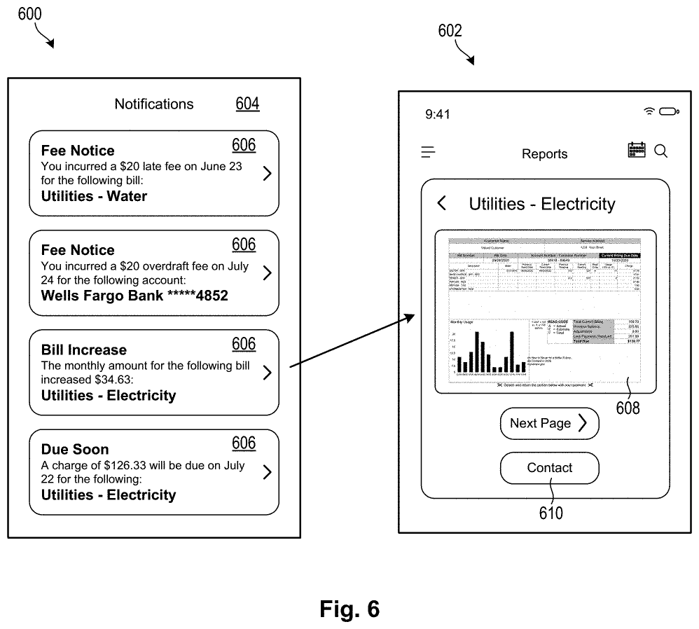

Referring to FIG. 6, in certain embodiments, notifications or alerts may be provided in a notification area 604 such as notification center or notification drawer of a user's mobile device, or in an analogous notification area of a PC, laptop, tablet, or the like. FIG. 6 shows one example of a user interface 600 providing a notification area 604. As shown, different types of alerts 606 or notifications 606 may appear in the notification area 604. In addition to providing useful information, clicking on or otherwise selecting one of these notifications 606 may take a user to a bill 608 that generated the alert. In certain embodiments, the user interface 602 that displays the bill 608 may enable the user to scroll or page through the bill 608 to further review and scrutinize it. In certain embodiments, a link 610 may be provided to contact a provider of the bill 608. This link 610 may automatically contact the provider (e.g., by initiating or generating a phone call, email, text message, or the like), or may link the user to contact information so that he or she may contact the provider. In certain embodiments, the billing module 200 automatically extracts the contact information from the bill 608.

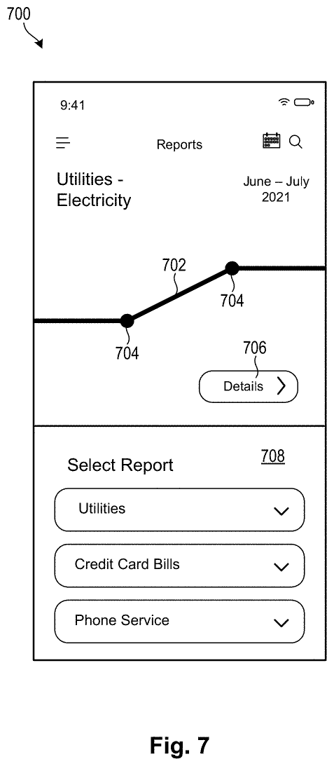

Referring to FIG. 7, in certain embodiments, the billing module 200 may be configured to generate different types of reports for a specific issuer of a bill 608, a specific bill 608, or a category of bills 608. FIG. 7 shows one embodiment of a user interface 700 displaying such a report. In the illustrated example, different reports may be selected in an area 708 of the user interface 700. In certain embodiments, these reports may be based on categories created by a user.

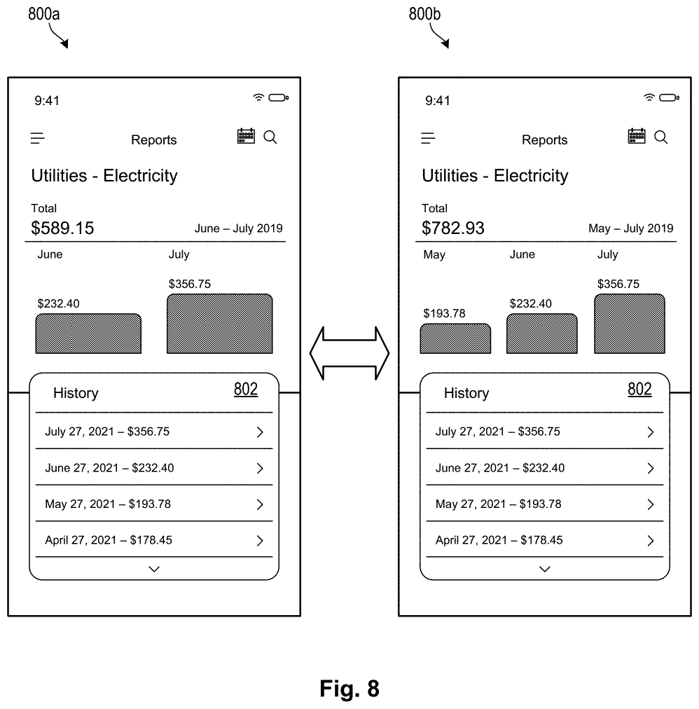

In this example, the user interface 700 displays a report for “electricity” in the category of “utilities.” In the illustrated embodiment, the user interface 700 displays a line graph 702 passing through points 704 representing amounts due for two different electricity bills 608, in this example two different months of electricity bills 608. In certain embodiments, two points 704 may be shown by default but more points 704 may be displayed as a user-configurable option (i.e., a timeframe selected by the user). The line graph 702 provides a quick way to notice differences in the amounts of the bills as well as to see in which direction amounts are trending, or to see patterns in usage or clear outliers. In certain embodiments, a details button 706 may be clicked or otherwise selected to provide additional information regarding a specific issuer of a bill 608, a specific bill 608, or a category of bills 608, as will be shown in more detail in association with FIG. 8.

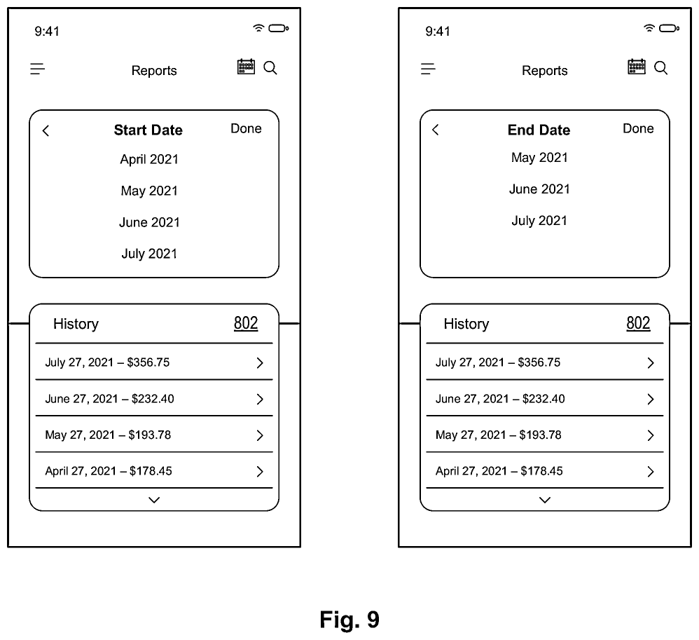

Referring to FIG. 8, a user interface 800 showing a report providing additional details about bills in the category of “Utilities—Electricity” is illustrated. In certain embodiments, such a user interface 800 may be displayed upon selecting the “details” option 706 in FIG. 7. As shown, the report provides a bar graph that documents amounts due for an electricity bill across several months. The user interface 800a shows amounts for two months and the user interface 800b shows amounts for three months. A “total” may indicate the sum of the bills that are displayed. The user interface 800a may be changed to the user interface 800b by changing the timeframe associated with the report. In certain embodiments, once the data exceeds a certain number of columns (i.e., bars in the bar graph), the data may be scrollable from right to left. FIG. 9 shows various user interfaces 900a, 900b comprising scroll wheels that may be used to change the timeframe associated with the data in FIG. 8.

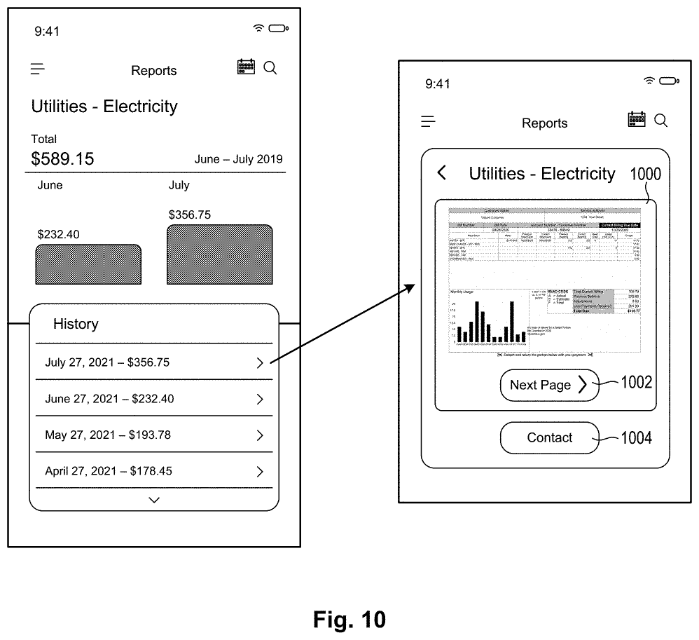

In the examples of FIGS. 8 and 9, a history 802 is provided of past bills 608 associated with a particular category or bill issuer. In addition to providing a history of the bills 608, each bill 608 in the list may link to additional information associated with the bill 608, as shown in FIG. 10. For example, clicking on a particular bill 608 in the list may link to a scanned image 1000 of the bill 608. In certain embodiments, an option 1002 may be provided to scroll or page through the bill 608. Similarly, in certain embodiments, a link 1004 may be provided to contact the bill issuer in the event some aspect of the bill 608 needs to be contested.

Referring to FIG. 11, as previously mentioned, in certain embodiments, the classification module 210 may enable a user to create or edit various categories that bills 608 may be sorted under. FIG. 11 shows one example of a user interface 1100 that may be used for this purpose. As shown in FIG. 11, a user may create over-arching categories such as “utilities,” “phone bills,” “credit card bills,” or the like. Within these over-arching categories, the user may create subcategories. For example, under the category of “utilities,” the user may create the subcategories of “water,” “electricity,” “gas.” Functionality may be provided to enable the user to add, delete, or edit the categories or subcategories. In certain embodiments, the user interface 1100 may include an area 1102 for unsorted bills 608. These bills 608 may be added to the categories or subcategories either automatically (using artificial intelligence, for example) or manually by a user.

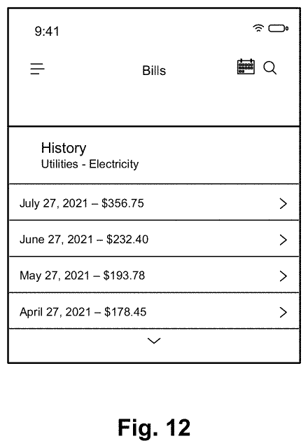

Referring to FIG. 12, in certain embodiments, a user interface 1200 may be provided to view bills 608 imported and categorized within the billing module 200. In the illustrated example, the user interface 1200 shows a history of electric bills 608 imported into the billing module 200. In this example, each bill 608 is listed with the date and amount of the bill 608. In certain embodiments, clicking on or selecting any of the bills 608 in the list may take the user to a copy of the bill 608, such as a scanned-in copy 1000 of the bill 608, like that shown in FIG. 10.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for aggregating and paying bills, the method comprising:
aggregating, by at least one processor from a plurality of sources, bills for goods or services rendered;
parsing, by the at the least one processor, the bills to determine amounts owed for the goods or services;
determining, by the at the least one processor, whether any of the amounts fall outside of acceptable ranges; and
prior to paying the bills, generating, by the at the least one processor, an alert in the event any of the amounts fall outside of the acceptable ranges.

2. The method of claim 1, further comprising analyzing the amounts over a period of time to determine the acceptable ranges.

3. The method of claim 1, further comprising determining due dates associated with the bills.

4. The method of claim 3, further comprising, prior to paying the bills, generating the alert in the event any of the due dates fall outside of a range of normal due dates.

5. The method of claim 1, further comprising, in the event any of the amounts fall outside of the acceptable ranges, linking the user to the bill that gave rise to the alert.

6. The method of claim 1, wherein determining whether any of the amounts fall outside of the acceptable ranges comprises determining whether any subcategories of the amounts fall outside of the acceptable ranges.

7. The method of claim 1, wherein determining whether any of the amounts fall outside of the acceptable ranges comprises determining whether any over-arching categories containing the amounts fall outside of the acceptable ranges.

8. A computer program product for aggregating and paying bills, the computer program product comprising a computer-readable storage medium having computer-usable program code embodied therein, the computer-usable program code configured to perform the following when executed by at least one processor:
aggregate, from a plurality of sources, bills for goods or services rendered;
parse the bills to determine amounts owed for the goods or services;
determine whether any of the amounts fall outside of acceptable ranges; and
prior to paying the bills, generate an alert in the event any of the amounts fall outside of the acceptable ranges.

9. The computer program product of claim 8, wherein the computer-usable program code is further configured to analyze the amounts over a period of time to determine the acceptable ranges.

10. The computer program product of claim 8, wherein the computer-usable program code is further configured to determine due dates associated with the bills.

11. The computer program product of claim 10, wherein the computer-usable program code is further configured to, prior to paying the bills, generate the alert in the event any of the due dates fall outside of a range of normal due dates.

12. The computer program product of claim 8, wherein the computer-usable program code is further configured to, in the event any of the amounts fall outside of the acceptable ranges, link the user to the bill that gave rise to the alert.

13. The computer program product of claim 8, wherein determining whether any of the amounts fall outside of the acceptable ranges comprises determining whether any subcategories of the amounts fall outside of the acceptable ranges.

14. The computer program product of claim 8, wherein determining whether any of the amounts fall outside of the acceptable ranges comprises determining whether any over-arching categories containing the amounts fall outside of the acceptable ranges.

15. A system for aggregating and paying bills, the system comprising:
at least one processor;
at least one memory device operably coupled to the at least one processor and storing instructions for execution on the at least one processor, the instructions causing the at least one processor to:
aggregate, from a plurality of sources, bills for goods or services rendered;
parse the bills to determine amounts owed for the goods or services;
determine whether any of the amounts fall outside of acceptable ranges; and
prior to paying the bills, generate an alert in the event any of the amounts fall outside of the acceptable ranges.

16. The system of claim 15, wherein the instructions further cause the at least one processor to analyze the amounts over a period of time to determine the acceptable ranges.

17. The system of claim 15, wherein the instructions further cause the at least one processor to determine due dates associated with the bills.

18. The system of claim 17, wherein the instructions further cause the at least one processor to, prior to paying the bills, generate the alert in the event any of the due dates fall outside of a range of normal due dates.

19. The system of claim 15, wherein determining whether any of the amounts fall outside of the acceptable ranges comprises determining whether any subcategories of the amounts fall outside of the acceptable ranges.

20. The system of claim 15, wherein determining whether any of the amounts fall outside of the acceptable ranges comprises determining whether any over-arching categories containing the amounts fall outside of the acceptable ranges.
